(19) United States
(12) Patent Application Publication
(10) Pub. No.: US 2023/0381552 A1
(43) Pub. Date: Nov. 30, 2023

(54) PROTECTIVE MASK

(71) Applicant: DISPOSITIVI PROTEZIONE INDIVIDUALE D.P.I. s.r.l., Rome (IT)

(72) Inventors: Romano MOSCATELLI, Rome (IT); Federica MORGIA, Rome (IT); Daniele PAGLICI, Rome (IT); Vittorio DE BLASIIS, Rome (IT)

(21) Appl. No.: 18/167,471

(22) Filed: Feb. 10, 2023

(30) Foreign Application Priority Data
Feb. 25, 2022 (IT) 102022000003629

(51) Int. Cl. A62B 18/08; A62B 18/04

(52) U.S. Cl. CPC A62B 18/082; A62B 18/04

(57) ABSTRACT

Described is a protective mask for civil or military use including a supporting frame comprising two identical lateral seats, positioned in a lower portion of the supporting frame and mirroring each other relative to a sagittal plane of the supporting frame, and a front seat located in an upper portion of the supporting frame, a protective lens anchored to the supporting frame to cover the front seat and an inhaling opening and an exhaling opening which are interchangeable housed or which can be can be housed in the lateral seats.

This application claims priority to Italian Patent Application 102022000003629 filed Feb. 25, 2022, the entirety of which is incorporated by reference herein.

This invention relates to a protective mask.

The invention operates in the field of personal protection at a civil and/or military level.

More specifically, the invention is aimed at protecting the respiratory tracts and the face in the context of possible exposure to substances of the gaseous type, vapours, aerosols and fibres of the industrial type and CBRN (Chemical, Biological, Radioactive and Nuclear), as well as splashes, particles and projections of fragments of various types.

No full face masks currently comply with all the requirements of the European technical standards defined for full face gas masks, together with the strength and ballistic protection requirements again according to international standards or specific requirements according to international standards or specific military technical specifications, which at the same time give a high level of compatibility with the operating conditions for use of weapons, sighting systems, optics or other similar devices.

The masks that aim to offer protection for the respiratory and digestive tracts against aggressive chemical agents in the form of gases, vapours and aerosols, also in a CBRN range, are currently divided into two categories.

A first category comprises the masks which adopt a rigid screen and a second category which, on the other hand, adopt a flexible screen.

Disadvantageously, the rigid screen does not offer the ability to adapt to operating conditions, whilst the flexible screen does not simultaneously achieve the required technical features of the field of vision, optical class and resistance to conventional weapons.

Moreover, in many military operational sectors it is necessary to provide the possibility of engaging the filter on the right or left side depending on whether the user is right or left-handed to limit the lateral dimensions in the use of sighting systems. This problem is normally resolved with a double coupling which increases the lateral dimensions and/or the absence of the phonic cartridge, adversely affecting the users who perform their activities.

The technical purpose of the invention is therefore to provide a protective mask which is able to overcome the drawbacks of the prior art.

The aim of the invention is therefore to provide a protective mask which offers flexibility and freedom in tactical military operations and in the movements.

A further aim of the invention is to provide a protective mask whose screen meets, as well as the minimum requirements of the European standards defined for full face gas masks, also the mechanical and chemical strength requirements, as well as optical features with shape and distance from the eyes such as to comply with “eye relief”, that is to say, the minimum distance between lens and eyepiece of the sighting optic necessary for managing the recoil of the weapon under normal conditions of use.

The technical purpose indicated and the aims specified are substantially achieved by a protective mask comprising the technical features described in one or more of the accompanying claims. The dependent claims correspond to possible embodiments of the invention.

In particular, the technical purpose indicated and the aims specified are substantially achieved by a protective mask for civil or military use comprising a supporting frame comprising two identical lateral seats, positioned in a lower portion of the supporting frame and mirroring each other relative to a sagittal plane of the supporting frame, and a front seat located in an upper portion of the supporting frame. The protective mask also comprises a protective lens anchored to the frame to cover the front seat or an inhaling opening and an exhaling opening housed or which can be housed in the seats and interchangeable with each other.

Further features and advantages of the invention are more apparent in the non-limiting description which follows of a non-exclusive embodiment of a protective mask.

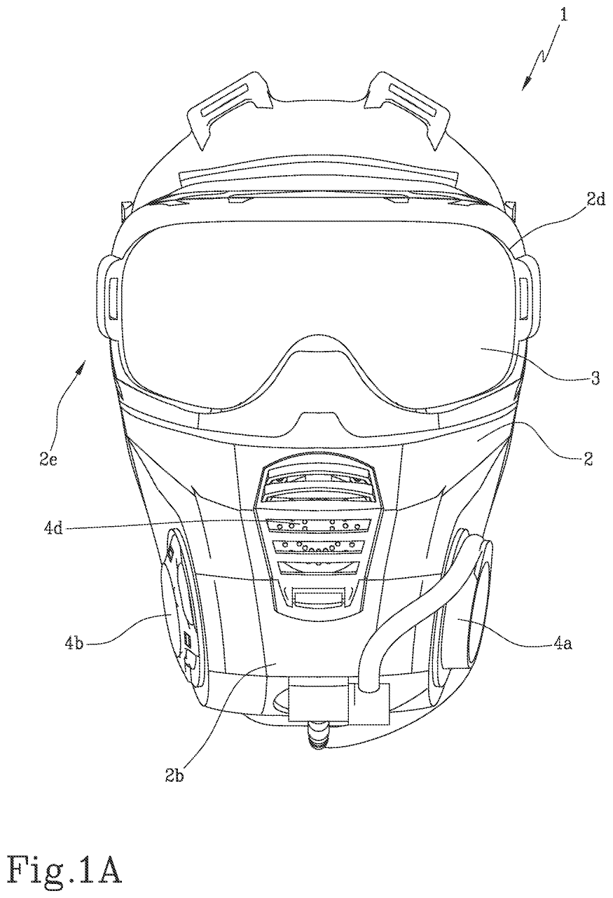

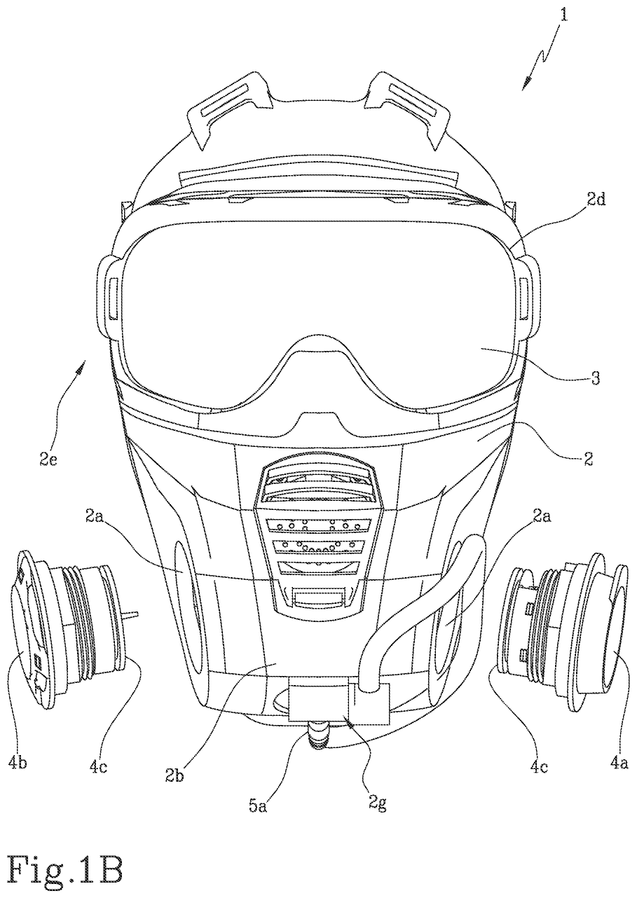

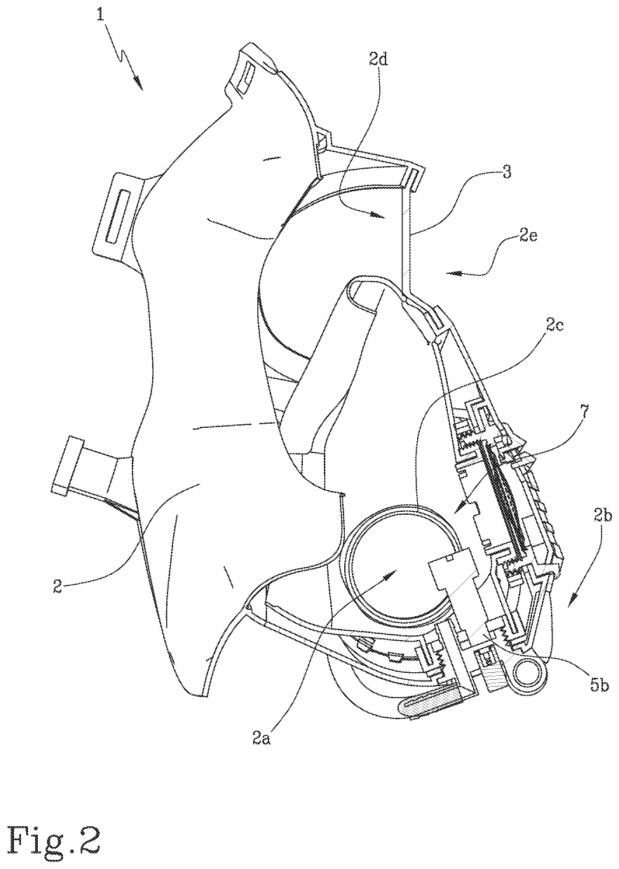

The description is set out below with reference to the accompanying drawings which are provided solely for purposes of illustration without restricting the scope of the invention and in which:
FIG. 1A is a front view of the protective mask according to the invention;
FIG. 1B is an exploded view of the protective mask according to the invention;
FIG. 2 is a side cross-section of the protective mask according to the invention.

With reference to the accompanying drawings, the numeral 1 denotes in its entirety a protective mask for civil or military use which, for simplicity of description, will hereafter be referred to as protective mask 1.

The protective mask 1 comprises a supporting frame 2 comprising two lateral seats 2a which are identical to each other and positioned in a lower portion 2b of the supporting frame 2. The lateral seats 2a mirror each other relative to a sagittal plane of the supporting frame 2, identifiable as the plane with which to obtain the cross-section of FIG. 2.

The term supporting frame 2 preferably means a rubber facial element.

Preferably, and as shown in the accompanying drawings, the lateral seats 2a comprise respective threaded rings 2c which are identical to each other and integral with the frame.

In the lower portion 2b there is also a central seat 2f for positioning a phonic device 4d and a lower central seat 2g. Preferably, the lower central seat 2g allows the presence of a device 5a for drinking liquids and/or a communication device 5b. The components just described are fastened and anchored to the supporting frame 2 in an inner portion of it.

The supporting frame 2 also comprises a front seat 2d located in an upper portion 2e of the supporting frame.

In other words, the lateral seats 2a are made in a portion of the mask located to protect the mouth of a user whilst the front seat 2d is located in a portion of the mask positioned to protect the eyes of the user.

Preferably, and as shown in the accompanying drawings, the supporting frame 2 may be made in the form of an outer frame and an inner frame 7 coupled to each other. The inner frame 7 is preferably structured to define the lateral seats 2a as well as the central seat 2f and the lower central unit 2g.

Preferably, the mask has six ties to be worn using a harness.

The protective mask 1 also comprises a protective lens 3 anchored to the supporting frame 2 to cover the front seat 2d. The protective lens 3 is therefore configured to protect the eyes of a user.

Preferably, the protective lens 3 is made of polycarbonate.

Preferably, the protective lens 3 is made of a flexible material.

Preferably, an optical correction is applied to the protective lens 3.

Preferably, the protective lens 3 has a profile obtained with a single curvature. In this way, the protective lens 3 makes it possible to avoid aberrations and optical distortions.

Preferably, the protective lens 3 is anchored to the supporting frame 2 by a liquid adhesive. The liquid adhesive allows a coupling to be made without a rigid anchoring system, thereby eliminating the traditional inner and outer frames. The liquid adhesive also guarantees a high level of seal and strength of the assembly.

Preferably, the supporting frame 2 is shaped in such a way that the protective lens 3, when anchored to cover the front seat, is at a predetermined distance from the eyes of a user. In this way, the protective mask 1 respects the operational needs for the use of additional sighting and optical systems. The predetermined distance therefore takes into account the need for using additional sighting and optical systems. In other words, the distance of the eyes complies with the “eye relief”, which consists in the minimum distance between the lens and the eyepiece of the sighting lens needed for managing the recoil of the weapon under normal conditions of use.

The protective lens 3 is therefore designed in such a way that the field of vision of the protective mask 1, when worn, meets the requirements of the European technical reference standards for full face gas masks.

The testing with regard to the above has been carried out using prototypes for validating the use of sighting and optical systems, confirming extremely favourable results.

The protective mask 1 also comprises a inhaling opening 4a and an exhaling opening 4b housed or which can be housed in the lateral seats 2a and interchangeable with each other. In other words, the openings 4a and 4b are interchangeably housed or able to be housed in the lateral seats 2a.

Preferably, the openings 4a and 4b comprise seats 4c for coupling the openings 4a and 4b to the lateral seats 2a of the supporting frame 2.

Preferably, the threaded rings 2c are configured to be coupled to the seats 4c of the openings 4a and 4b.

Since the seats 4c are identical and the lateral seats 2a are identical, the interchangeability of the inhaling opening 4a and the exhaling opening 4b is guaranteed and facilitated.

The interchangeability of the openings 4a and 4b was tested through the above-mentioned prototypes, with removal and refitting without adversely affecting the rest of the mask.

The seats 4c are housed in the two identical lateral seats 2a on which are fastened the two identical rings 2c which remain integral with the supporting frame 2 to prevent them from being lost during the change of position. These two identical threaded rings 2c are coupled with both the seats 4c making their positioning absolutely interchangeable.

The protective mask 1 may have, in place of the openings 4a and 4b, a system for protecting the respiratory tracts with positive pressure applied or applicable to the lateral seats 2a. According to this embodiment, the openings 4a and 4b are replaced with special valve units for breathing in and out and applied or applicable to the lateral seats 2a. In other words, this embodiment is completely identical to the previous embodiment with the exception of the system for protecting the respiratory tracts with positive pressure instead of the openings 4a and 4b.

Advantageously, the invention is able to overcome the drawbacks of the prior art.

Advantageously, the protective mask 1 is able to combine the performance of the traditional masks for civil use with the requirements of military operating fields.

Advantageously, the protective mask 1 allows a facilitated maintenance without the use of specific equipment.

Advantageously, the protective mask 1 has a high flexibility with reduced overall dimensions.

Advantageously, the interchangeability of the inhaling and exhaling opening occurs safely and is easily performed also by a trained operator.

1. A protective mask for civil or military use comprising:
a supporting frame comprising two identical lateral seats, positioned in a lower portion of the supporting frame and mirroring each other relative to a sagittal plane of the supporting frame, and a front seat located in an upper portion of the supporting frame;
a protective lens anchored to said supporting frame to cover said front seat; and
a inhaling opening and an exhaling opening which are interchangeably housed or which can be housed in said lateral seats.

2. The protective mask according to claim 1, wherein said protective lens is made of polycarbonate or flexible material.

3. The protective mask according to claim 1, wherein said protective lens is anchored to the supporting frame by means of liquid adhesive.

4. The protective mask according to claim 1, wherein an optical correction is applied to said protective lens.

5. The protective mask according to claim 1, wherein said protective lens has a profile obtained by means of a single curvature.

6. The protective mask according to claim 1, wherein said supporting frame is shaped in such a way that said protective lens, when anchored to cover the front seat, has a predetermined distance from the eyes of a user.

7. The protective mask according to claim 1, wherein said lateral seats comprise respective threaded rings identical to each other and integral with the supporting frame.

8. The protective mask according to claim 1, wherein said openings comprise seats for coupling the openings to the lateral seats of the supporting frame.

9. The protective mask according to claim 7, wherein said threaded rings are configured to be coupled to the seats of said openings.

10. A protective mask for civil or military use comprising:
a supporting frame comprising two identical lateral seats, positioned in a lower portion of the supporting frame and mirroring each other relative to a sagittal plane of the supporting frame, and a front seat located in an upper portion of the supporting frame;
a protective lens anchored to said supporting frame to cover said front seat;
a system for protecting the respiratory tracts with positive pressure applied or applicable to said lateral seats.
